(19) United States
(12) Patent Application Publication
(10) Pub. No.: US 2026/0261534 A1
(43) Pub. Date: Sep. 3, 2026

(54) INFORMATION PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Qingtao HU, Beijing (CN); Shi QIU, Beijing (CN); Bofei ZHANG, Beijing (CN)

(21) Appl. No.: 18/994,551

(22) PCT Filed: Sep. 1, 2023
(86) PCT No.: PCT/CN2023/116614

§ 371 Date: Jan. 14, 2025

(30) Foreign Application Priority Data
Sep. 22, 2022 (CN) 202211161735.3

(51) Int. Cl. H04L 51/046; H04L 12/18; H04L 51/224

(52) U.S. Cl. CPC H04L 51/046; H04L 12/185; H04L 51/224

(57) ABSTRACT

The present application provides an information processing method and apparatus, an electronic device, and a storage medium. The method includes: obtaining group member change information of a first group, wherein the first group is associated with a first object in a first system, and the first system is a different system from a communication system where the first group is located; and modifying a team member list corresponding to the first object in the first system based on the group member change information, wherein users in the team member list have a first access permission to information of the first object in the first system. user.

### CROSS-REFERENCE TO RELATED APPLICATION(S)

The present application claims priority to Chinese Application No. 202211161735.3, filed on Sep. 22, 2022, and entitled “INFORMATION PROCESSING METHOD AND APPARATUS, ELECTRONIC DEVICE, AND STORAGE MEDIUM”, which is incorporated herein by reference in its entirety.

### TECHNICAL FIELD

The present application relates to the field of data processing technologies, and in particular, to an information processing method and apparatus, an electronic device, and a storage medium.

### BACKGROUND

In some technologies, an information management system is used to maintain information of a target object, such as a project information management system, a product information management system, or a customer information management system. In these information management systems, there is a team for each target object (such as a project/product/customer) to perform collaborative work around the target object. In addition, in a collaborative work scenario, a communication group (referred to as a group; for example, a group chat in an instant messaging application) is an important tool for communication.

Therefore, in some related technologies, a communication group is bound to a target object in an information management system, so that information updated or recorded by team members of the target object in the information management system is automatically synchronized to the bound communication group. In this way, team members of the target object can directly view information related to the target object in the communication group without logging in to the information management system, thereby greatly improving work efficiency. In this case, group members are usually consistent with or mostly overlap team members of the target object.

Currently, if team members of a target object change, a person in charge of the target object needs to separately update a team member list in the information management system and add/remove group members bound to the target object. This manual modification is cumbersome and reduces work efficiency.

### SUMMARY

In view of this, an objective of the present application is to provide an information processing method and apparatus, an electronic device, and a storage medium to solve or partially solve the above technical problems.

Based on the above objective, a first aspect of the present application provides an information processing method. The method includes:
obtaining group member change information of a first group, where the first group is associated with a first object in a first system, and the first system is a different system from a communication system where the first group is located; and
modifying a team member list corresponding to the first object in the first system based on the group member change information, where a user in the team member list has a first access permission to information of the first object in the first system.

Based on the same inventive concept, a second aspect of the present application provides an information processing method. The method includes:
obtaining team member list change information corresponding to a first object in a first system, where a user in the team member list has a first access permission to information of the first object in the first system; and
changing a group member of a first group based on the team member list change information, where the first group is associated with the first object in the first system, and the first system is a different system from a communication system where the first group is located.

Based on the same inventive concept, a third aspect of the present application provides an information processing method. The method includes:
obtaining a notification message determined based on group member change information of a first group, where the first group is associated with a first object in a first system, and the first system is a different system from a communication system where the first group is located;
sending the notification message to the first group, where the notification message is visible only to a first user in the first group, and the first user is an administrator of a group member of the first group and a team member corresponding to the first object; and
receiving operation feedback information of the first user for the notification message, and sending the operation feedback information to the first system, for the first system to modify a team member list corresponding to the first object in the first system based on the operation feedback information.

Based on the same inventive concept, a fourth aspect of the present application provides an information processing apparatus. The apparatus includes:
a change information obtaining module configured to obtain group member change information of a first group, where the first group is associated with a first object in a first system, and the first system is a different system from a communication system where the first group is located; and
a member modifying module configured to modify a team member list corresponding to the first object in the first system based on the group member change information, where a user in the team member list has a first access permission to information of the first object in the first system.

Based on the same inventive concept, a fifth aspect of the present application provides an information processing apparatus. The apparatus includes:
a team member change obtaining module configured to obtain team member list change information corresponding to a first object in a first system, where a user in the team member list has a first access permission to information of the first object in the first system; and
a group member change module configured to change a group member of a first group based on the team member list change information, where the first group is associated with the first object in the first system, and the first system is a different system from a communication system where the first group is located.

Based on the same inventive concept, a sixth aspect of the present application provides an information processing apparatus. The apparatus includes:
a notification receiving module configured to receive a notification message sent by a first system, where the notification message is determined based on group member change information of a first group, where the first group is associated with a first object in the first system, and the first system is a different system from a communication system where the first group is located;
a notification sending module configured to send the notification message to the first group, where the notification message is visible only to a first user in the first group, and the first user is an administrator of a group member of the first group and a team member corresponding to the first object; and
an operation feedback module configured to receive operation feedback information for the notification message, and send the operation feedback information to the first system, for the first system to modify a team member list corresponding to the first object in the first system based on the operation feedback information.

Based on the same inventive concept, a seventh aspect of the present application provides an electronic device. The electronic device includes a memory, a processor, and a computer program stored in the memory and executable on the processor. The processor implements the method according to the first aspect, the second aspect, or the third aspect when executing the program.

Based on the same inventive concept, an eighth aspect of the present application provides a non-transitory computer-readable storage medium. The non-transitory computer-readable storage medium stores computer instructions that are configured to cause a computer to perform the method according to the first aspect, the second aspect, or the third aspect.

It can be learned from the above descriptions that the information processing method and apparatus, the electronic device, and the storage medium provided in the present application can modify a team member list of an object corresponding to a group that is stored in a first system when a group member in the group changes. In this modification method, a user does not need to enter the first system again to repeatedly modify a corresponding team member list, so that the modification process is more intelligent, simple, quick, and convenient for the user.

### BRIEF DESCRIPTION OF THE DRAWINGS

In order to describe the technical solutions in the present application or the related art more clearly, the following briefly introduces the accompanying drawings required for describing the embodiments or the related art. It is apparent that the accompanying drawings in the following description merely show some embodiments of the present application, and a person of ordinary skill in the art may still derive other drawings from these accompanying drawings without creative efforts.

FIG. 1 is a schematic diagram of an application scenario according to an embodiment of the present application;

FIG. 2 is a flowchart of an information processing method according to an embodiment of the present application;

FIG. 3 is a flowchart of an information processing method according to another embodiment of the present application;

FIG. 4 is a flowchart of an information processing method according to still another embodiment of the present application;

FIG. 5A is an execution flowchart corresponding to a group member addition according to an embodiment of the present application;

FIG. 5B-1 is a schematic diagram of an added reminder card 1 according to an embodiment of the present application;

FIG. 5B-2 is another schematic diagram of the added reminder card 1 according to an embodiment of the present application;

FIG. 5B-3 is a schematic diagram of role selection performed on the added reminder card 1 according to an embodiment of the present application;

FIG. 5B-4 is a schematic diagram of an added reminder card 2 according to an embodiment of the present application;

FIG. 5B-5 is a schematic diagram of an added reminder card 3 according to an embodiment of the present application;

FIG. 5B-6 is a schematic diagram of an added reminder card 4 according to an embodiment of the present application;

FIG. 5C is an execution flowchart corresponding to a group member removing according to an embodiment of the present application;

FIG. 5D-1 is a schematic diagram of a removing reminder card 1 according to an embodiment of the present application;

FIG. 5D-2 is a schematic diagram of a removing reminder card 2 according to an embodiment of the present application;

FIG. 5D-3 is a schematic diagram of a removing reminder card 3 according to an embodiment of the present application;

FIG. 6 is a block diagram of a structure of an information processing apparatus according to an embodiment of the present application;

FIG. 7 is a block diagram of a structure of an information processing apparatus according to another embodiment of the present application;

FIG. 8 is a block diagram of a structure of an information processing apparatus according to still another embodiment of the present application; and

FIG. 9 is a schematic diagram of a structure of an electronic device according to an embodiment of the present application.

### DETAILED DESCRIPTION

It may be understood that data (including but not limited to the data itself, data acquisition, or data use) involved in the technical solution of this application shall comply with requirements of corresponding laws, regulations, and relevant provisions.

The principles and spirit of the present application will be described below with reference to several exemplary embodiments. It should be understood that the given embodiments are merely provided for those skilled in the art to better understand and then implement the present application, but not to limit the scope of the present application in any way. Instead, these embodiments are provided to make the present application more thorough and complete, and the scope of the present application can be completely conveyed to those skilled in the art.

It may be understood that before the technical solutions of the embodiments of the present disclosure are used, the user is notified of the type, scope of use, and usage scenarios of personal information involved through an appropriate manner, and the user is authorized.

For example, when a user's active request is received, notification information is sent to the user to explicitly notify the user that the operation requested by the user needs to acquire and use the user's personal information. Therefore, the user can independently choose whether to provide personal information to a software or hardware such as an electronic device, an application, a server, or a storage medium that performs an operation of the technical solution of the present disclosure based on the notification information.

As an optional but non-limiting implementation, for example, the notification information may be sent to the user in a pop-up window in response to receiving the user's active request. The notification information may be presented in text in the pop-up window. In addition, the pop-up window may further carry a selection control for the user to select “Agree” or “Disagree” to provide personal information to the electronic device.

It may be understood that the above notification and user authorization process is merely illustrative and does not limit the implementation of the present disclosure. Other methods that meet relevant laws and regulations may also be applied to the implementation of the present disclosure.

It should be understood that, in this article, any quantity of elements in the accompanying drawings is used for example rather than limitation, and any naming is only used for distinction, without any limiting meaning.

Based on the descriptions of the background technology, taking a project information management system as an example, the related art has the following situation:

Background: A user does not maintain a project team list (that is, a team member list) in a project information management system (that is, used to store the team member list of an object corresponding to each group) in advance. After a project group is created in an instant messaging program, the project group usually includes only a project administrator (that is, a group member in the project group and an administrator of the team member list) and a whitelist member. The user is accustomed to directly pull a collaborator (that is, an added group member) into the project group in the project group.

Pain point 1: After the collaborator is pulled in, the collaborator does not directly enter the project team. The project administrator needs to additionally maintain the project team. The collaborator is almost equivalent to a member of the project team. This means that the project administrator needs to perform an operation twice in the project group in the instant messaging program and a corresponding team member list in the project information management system to complete the process of adding the collaborator.

Pain point 2: The project administrator has no motivation to additionally maintain the project team list in the project information management system, which may result in that the project team list is not used, and this may affect normal use of other functions corresponding to the project team list.

Based on the situation described above, the principles and spirit of the present application are explained in detail below with reference to several representative embodiments of the present application.

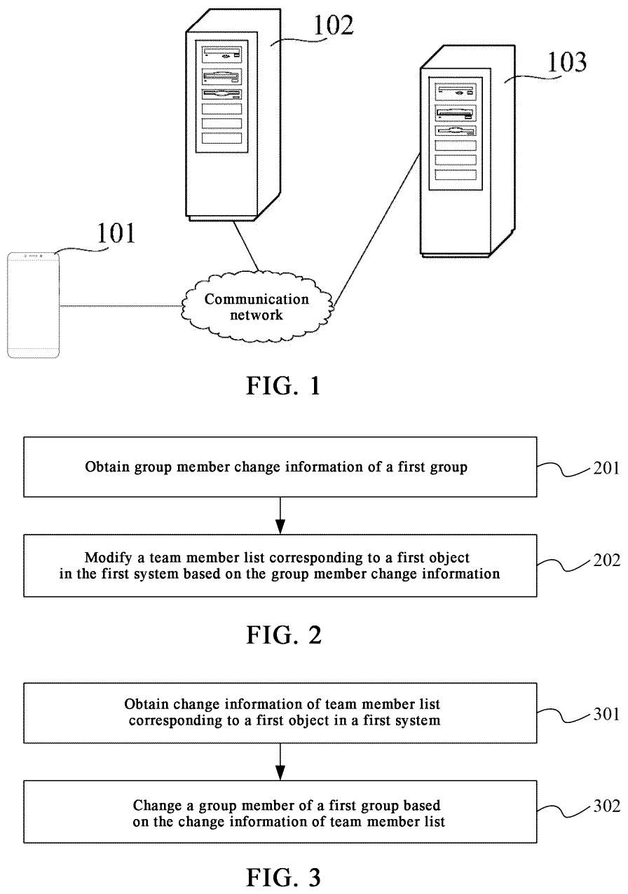

FIG. 1 is a schematic diagram of an application scenario of an information processing method according to an embodiment of the present application. The application scenario includes a terminal device 101, a server 102, and a data storage system 103. The terminal device 101, the server 102, and the data storage system 103 may be connected through a wired or wireless communication network. The terminal device 101 includes but is not limited to a desktop computer, a mobile phone, a mobile computer, a tablet computer, a media player, a smart wearable device, a personal digital assistant (PDA), or another electronic device that can implement the foregoing functions. Both the server 102 and the data storage system 103 may be an independent physical server, a server cluster or distributed system including a plurality of physical servers, or a cloud server that provides basic cloud computing services such as cloud service, cloud database, cloud computing, cloud function, cloud storage, network service, cloud communication, middleware service, domain name service, security service, CDN, big data, and artificial intelligence platform.

The terminal device 101 is installed with a corresponding instant messaging software. After a group member of a first group pulls a member into the first group by using the instant messaging software, group member change information is generated and sent to the server 102 corresponding to the first system. The first system obtains, based on the group member change information, a team member list of a first object corresponding to the first group, and modifies the team member list based on the group member change information. For example, the group member change information is added group member information, and an added group member is added to the team member list as a new team member. Alternatively, the group member change information is group member reduction information, and a team member corresponding to a removed group member is removed from the team member list. The data storage system 103 provides data storage support for the operation of the server 102, for example, is used to store program code that can implement the foregoing process.

The information processing method according to an exemplary embodiment of the present application is described below with reference to the application scenario in FIG. 1. It should be noted that the foregoing application scenario is merely shown for ease of understanding the spirit and principle of the present application, and the implementation of the present application is not limited in this regard. Instead, the implementation of the present application may be applied to any applicable scenario.

An embodiment of the present application provides an information processing method. As shown in FIG. 2, the method includes:
Step 201: Obtaining group member change information of a first group, where the first group is associated with a first object in a first system, and the first system is a different system from a communication system where the first group is located.

In specific implementation, when a group member of the first group changes, the group member change information of the first group can be obtained. In this way, the group member change information of the first group may be sent to the first system for subsequent modification processing on a team member list in the first system.

The first group corresponds to the first object, and the first system also stores a team member list corresponding to the first object. The team members in the team member list correspond to the group members in the first group. Members of the two are completely consistent or mostly overlap. For example, a number of team members in the team member list is less than or equal to a number of group members in the first group, or a number of team members in the team member list is greater than a number of group members in the first group.

Step 202: Modifying a team member list corresponding to the first object in the first system based on the group member change information, where a user in the team member list has a first access permission to information of the first object in the first system.

In specific implementation, the team member list includes names and identities of the team members, a corresponding access permission, and some data content of the team members about the first object (for example, if the first object is a purchase project of a product, the data content may be a purchase quantity, a purchase time, a purchase price, etc.).

After receiving the group member change information, the team member list of the first object corresponding to the first group in the first system is modified. In this modification method, the user can directly complete the modification in the first group, without the need to enter the first system again to repeatedly modify the corresponding team member list, so that the modification process is more intelligent, simple, quick, and convenient for the user.

In some embodiments, step 202 includes:

Step 2021: Sending a notification message in the first group based on the group member change information.

In specific implementation, when the first system determines that a group member of the first group changes, a notification message is correspondingly generated. A specified chat-bot is preset in the first group, and the specified chat-bot is usually a group member of the first group. The specified chat-bot sends the notification message to the first group. The notification message may be visible to all group members, or may be visible to some group members with a permission. The setting may be performed based on an actual requirement.

Step 2022: Modifying the team member list corresponding to the first object in the first system based on operation feedback information for the notification message.

In specific implementation, only a group member with a corresponding management permission in the first group can operate on the notification message. After the operation is completed, the operation feedback information is generated. When determining that the first group obtains the operation feedback information for the notification message, the instant messaging system sends the operation feedback information to the first system. In this way, the first system can determine, based on the operation feedback information, whether to modify the team member list of the corresponding first object. If the operation feedback information indicates that the team member list needs to be modified, the team member list is added to, changed, or removed. If the operation feedback information indicates that the team member list does not need to be modified, the team member list is not modified.

The foregoing solution can generate a corresponding notification message based on the group member change and send the notification message to the first group. In this way, a group member with a management permission for the team member list in the first group can modify and control the team member list based on the notification message. The operation is simple and convenient.

In some embodiments, the sending a notification message in the first group includes: sending a notification message that is visible only to a first user in the first group, where the first user is an administrator of a group member of the first group and a team member corresponding to the first object; and
the operation feedback information for the notification message includes: operation feedback information of the first user for the notification message.

In specific implementation, a confirmation control is provided in the notification message, and a user can directly trigger the confirmation control after performing an operation. Alternatively, the confirmation control does not appear in the notification message before the first user performs an operation on the notification message. If the first user performs an operation on whether to modify the team member list for the notification message, the confirmation control appears in the notification message. The confirmation control may be set at any position of a blank position of the notification message, and is preferably set at the bottom of the notification message.

The foregoing solution sets the notification message to be visible only to the first user, to avoid disturbing other group members. In addition, the first user can directly perform an operation based on the notification message in the first group to obtain the operation feedback information, without the need to open the first system to modify the team member list through the first system. In this way, the first user does not need to perform a repeated operation, and the entire modification process of the team member list is simple and quick, so that the first user is more motivated to maintain the team member list, and other functions in the first system based on the team member list can be fully utilized, thereby fully reflecting the use value of the first system.

In some embodiments, when the group member change information indicates that a group member is added, the notification message is a new team member notification message; and/or
when the group member change information indicates that a group member is removed, the notification message is a notification message of removing a team member.

In specific implementation, the notification message is divided into a new team member notification message and/or a notification message of removing a team member. The notification message may be a notification card or a notification window. In this way, the first user can directly perform an operation on whether to modify the team member list on the notification message in the first group, and the operation is convenient and quick.

In some embodiments, step 2021 includes:

Step 20211: In response to the group member change information indicating that a group member is added, obtaining added group member information from the group member change information.

In specific implementation, a number of added group members in the corresponding group member change information is at least one, and a number of pieces of added group member information obtained therefrom is also at least one.

Step 20212: Determining whether the added group member information is in the team member list corresponding to the first object.

In specific implementation, a team member list is screened for each piece of added group member information. If it is determined that a specific piece of added group member information is already in the team member list, a subsequent modification process is not performed.

Step 20213: In response to the team member list not including the added group member information, generating the notification message of adding a team member and sending the notification message of adding a team member in the first group, where the notification message of adding a team member comprises the added group member information.

In specific implementation, the first system determines that the team member list does not include the added group member information, and then generates the new team member notification message. The new team member notification message is sent to the first group by using a specified chat-bot of the first group. After seeing the new team member notification message in the first group, the first user can perform modification confirmation based on the new team member notification message, to confirm whether each added group member needs to be added to the team member list, and obtain corresponding operation feedback information.

According to the foregoing solution, after receiving operation feedback information corresponding to the new team member notification message, the first system confirms added group member information that can be added to the team member list, and adds the added group member information to the team member list as new team member information.

In some embodiments, the new team member notification message includes the added group member information and a role selection control, where the role selection control includes at least one candidate role information.

Step 2022 includes:

Step 20221: Determining that the operation feedback information for the notification message comprises at least one target role information selected by the first user for the added group member information through the role selection control, where the target role information is any of the at least one candidate role information.

In specific implementation, the first system adds a corresponding role selection control for each piece of added group member information in the new team member notification message, so that the user can select one or more corresponding pieces of target role information for the corresponding added group member by using the role selection control.

Step 20222: Adding the added group member information to the team member list corresponding to the first object in the first system as new team member information, and assigning the at least one target role information to the new team member information, where different roles of the team members correspond to different permissions of the first object.

In specific implementation, if the operation feedback information indicates that the added group member is not to be added, the team member list is not modified. If the operation feedback information indicates that the added group member is to be added, the added group member information is added to the team member list as new team member information, and at least one target role information carried in the operation feedback information and corresponding to the new team member information is obtained. The at least one target role information is assigned to the new team member information. In this way, the new team member (that is, the added group member) has the permission corresponding to the assigned target role information. The corresponding permission may be a permission such as viewing, calling, or modifying related data of the first object in the first system.

According to the foregoing solution, different added group members may be assigned different roles in the team member list, so that corresponding data management is performed based on the roles of the team members in the team member list, and functions of the first system are more diverse and comprehensive.

In some embodiments, a process of determining the notification message of removing a team member in step 2021 includes:

Step 20211′: In response to determining that the group member change information indicates that a group member is removed, obtaining removed group member information from the group member change information.

In specific implementation, in response to determining that the group member change information indicates that a group member is removed (for example, one or more group members are pulled out of the first group), at least one removed group member information is obtained from the group member change information.

Step 20212′: Determining whether the removed group member information is in the team member list corresponding to the first object.

Step 20213′: In response to the team member list including a team member corresponding to the removed group member information, generating a notification message of removing the team member.

In specific implementation, if a specific piece of removed group member information is not in the team member list, the team member list does not need to be operated on, and the notification message of removing a team member does not need to be generated. If the team member list includes the team member corresponding to the removed group member information, the notification message of removing a team member is generated and sent to the first group by using the specified chat-bot in the foregoing processing process of the added group member information, so that the notification message of removing a team member is visible to the first user with the administrator permission but invisible to other group members.

In this way, the first user can perform an operation based on the notification message of removing a team member in the first group to determine whether the removed group member information needs to be removed from the team member list. Then the team member list is modified based on corresponding operation feedback information. If the first user determines not to remove the removed group member information, the team member list is not operated on. If the first user determines to remove the removed group member information, the team member corresponding to the removed group member information is removed from the team member list.

According to the foregoing solution, the first user can control whether a removed group member in the first group needs to be removed from the corresponding team member list. The removing process is convenient and quick, thereby improving the performance of the first system.

In some embodiments, step 202 includes:

Step 2021′: In response to determining that the group member change information indicates that a group member is removed, obtaining removed group member information from the group member change information.

Step 2022′: Determining whether the removed group member information is in the team member list corresponding to the first object.

Step 2023′: In response to the team member list including the team member corresponding to the removed group member information, removing, from the team member list corresponding to the first object in the first system, the team member corresponding to the removed group member information, to complete the modification of the team member list.

In specific implementation, when it is confirmed that a group member of the first group is removed, if the team member list does not include a team member corresponding to the removed group member information, the team member list is not operated on. If the team member list includes the team member corresponding to the removed group member information, the team member is removed from the team member list.

According to the foregoing solution, when a group member in the first group is removed, it is proved that the group member is no longer related to the corresponding first object. The first system can directly remove the group member from the team member list without the need for the first user to confirm whether to remove the group member. In this way, the operation process can be saved, and the intelligence and convenience of the first system are further improved.

In some embodiments, after the modification of the team member list is completed, the method further includes:
sending, in the first group, a team member change result notification message that is visible only to the first user based on a modification result of the team member list.

In specific implementation, after a modification process of the team member list (the modification process may be a modification operation or a non-modification operation) is completed, a corresponding modification result (for example, modification succeeds or modification fails) is obtained. In this way, the first system can generate a team member change result notification message based on the modification result, and then send the team member change result notification message to the first group by using the specified chat-bot. The team member change result notification message is also visible only to the first user who is an administrator, to avoid disturbing other members in the group. The first user can learn, based on the team member change result notification message, the modification result of the team member list, and can handle a problem in a timely manner if any.

In some embodiments, the team member change result notification message includes at least one of:
a team member adding success message, a team member adding failure message, a team member removing success message, or a team member removing failure message.

In specific implementation, the team member change result notification message may include one or more messages of team member change. If there is only one added or removed group member, any of the foregoing team member change result notification messages is directly generated based on the modification result.

If the group member addition is performed, the corresponding team member change result notification message is the new team member adding success message and/or the team member adding failure message. If there are a plurality of added group members added to the first group at one time, and all the added group members are successfully added to the team member list, a message indicating that all the new team members are successfully added is directly generated. If some group members are successfully added to the team member list, it is determined that the group members successfully added obtain the new team member adding success message, and the group members whose addition fails obtain the team member adding failure message, and the messages are respectively reflected in the team member change result notification message. If all the added group members fail to be added to the team member list, a message indicating that all the new team members fail to be added is generated.

If the group member removing is performed, the corresponding team member change result notification message is the team member removing success message and/or the team member removing failure message. If there are a plurality of removed group members in the first group at one time, and all the removed group members are successfully removed from the team member list, a message indicating that all the removed group members are successfully removed is directly generated. If some group members are successfully removed from the team member list, it is determined that the group members successfully removed obtain the team member removing success message, and the group members whose removing fails obtain the team member removing failure message, and the messages are respectively reflected in the team member change result notification message. If all the removed group members fail to be removed from the team member list, a message indicating that all the removed group members fail to be removed is generated.

In addition, corresponding failure cause notification content may be added to the team member change result notification message. After it is determined that the modification fails, the first system automatically retries, and sends, after retrying for a plurality of times, the team member change result notification message corresponding to the obtained modification result to the first group by using the specified chat-bot, so that the first user can view the team member change result notification message in the first group.

In some embodiments, determining that the team member change result notification message includes: in response to a team member adding failure message or a team member removing failure message, carrying a contact entry of a system administrator and/or a contact entry of a feedback group in the team member change result notification message.

In specific implementation, to facilitate the operation of the first user, the corresponding contact entry of the system administrator and/or the contact entry of the feedback group are displayed together in the team member change result notification message, so that the first user can trigger to feed back the situation to the corresponding system administrator or the feedback group, so that the corresponding situation can be solved as soon as possible, further facilitating the use of the user.

In some embodiments, the team member adding failure message includes at least one of:
the team member adding failure message obtained in response to determining that the added group member information is not in the first group;
the team member adding failure message obtained in response to determining that no target role information is selected for the added group member information;
the team member adding failure message obtained in response to determining that the added group member information is already in the selected target role information;
the team member adding failure message obtained in response to determining that the added group member information is operated by an administrator other than the first user in administrators of team members corresponding to the first object;
the team member adding failure message obtained in response to determining that the added group member information cannot be added to the team member list corresponding to the first object; and
the team member adding failure message obtained in response to determining that the first user operating the added group member information has no administrator permission.

In specific implementation, if it is determined that one or more of the foregoing situations occur when the team member list is modified based on the operation feedback information in the case of added group members, the team member change result notification message is determined as the team member adding failure message. A corresponding failure cause may be added to the corresponding team member adding failure message to notify the first user, so that the first user can learn the cause.

In some embodiments, the team member removing failure message includes at least one of:
the team member removing failure message obtained in response to determining that role information corresponding to the removed group member information is not in the team member list corresponding to the first object; and
the team member removing failure message obtained in response to determining that the removed group member information cannot be removed from the team member list corresponding to the first object.

In specific implementation, if it is determined that one or more of the foregoing situations occur when the team member list is modified based on the operation feedback information or directly in the case of removed group members, the team member change result notification message is determined as the team member removing failure message. A corresponding failure cause may be added to the corresponding team member removing failure message to notify the first user, so that the first user can learn the cause.

In some embodiments, before step 2022, the method further includes:

Step A: In response to receiving an addition message of an added group member rejoining the first group after receiving an exit message of the added group member exiting the first group, generating a new notification message, and sending the new notification message in the first group.

In specific implementation, before the first user clicks the confirmation control in the notification message based on the notification message, there may be a situation where a group member exits and then rejoins. In this case, a new notification message is generated after the group member rejoins and sent to the first group. The first user can perform a new operation on the team member list in the notification message or the new notification message, or can perform a corresponding operation in both the notification message and the new notification message.

Step 2022 includes:
modifying the team member list corresponding to the first object in the first system based on the operation feedback information for the notification message and/or the new notification message.

In specific implementation, if any of the two notifications obtains the corresponding operation feedback information, and the operation feedback information carries the role selection for the corresponding added group member, the role selected for any of the two notifications is directly assigned to the corresponding new team member information added to the team member list.

If both the two notifications obtain the corresponding operation feedback information, it is determined whether the corresponding roles in the two operation feedback information are the same. If the roles are the same, the role is assigned to the corresponding new team member information added to the team member list. If the roles are different, at least two of the corresponding roles in the two operation feedback information are all assigned to the corresponding new team member information added to the team member list.

According to the solutions of the foregoing embodiments, when a group member of the first group is added or removed, a corresponding operation of adding or removing a team member can be performed on a team member list of a first object corresponding to the first group on a side of the first system. For the first user who is a group member of the first group and an administrator of a team member corresponding to the first object, the addition or removing of the group member and the addition or removing of the corresponding team member list can be directly completed in the first group. The entire operation process is simple and quick, bringing convenience to the first user, so that the first user is more willing to maintain the team member list in the first system, thereby ensuring that functions of the team member list can be fully exerted.

In specific implementation, an execution entity corresponding to the information processing method in each of the embodiments corresponding to FIG. 2 may be the first system (for example, the project information management system), or may be an instant messaging system (Instant Messaging, IM), or may be that the first system and the instant messaging system complete the information processing method in a collaborative manner. When the two complete the information processing method in a collaborative manner, a specific execution process allocation may be adjusted based on an actual requirement, which is not specifically limited here.

For example, it is determined that the first system executes the information processing method.

Based on the same inventive concept, an embodiment of the present application provides an information processing method. As shown in FIG. 3, the method includes:

Step 301: Obtaining team member list change information corresponding to a first object in a first system, where a user in the team member list has a first access permission to information of the first object in the first system.

In specific implementation, when a team member list corresponding to the first object in the first system changes (for example, a member is added or a member is removed), the team member list change information can be obtained. In this way, the team member list change information may be sent to the first system, so that the first system performs subsequent modification processing on the team member list.

The first system also stores a team member list corresponding to the first object. The first group corresponds to the first object. The team members in the team member list correspond to the group members in the first group. Members of the two are completely consistent or mostly overlap). For example, a number of team members in the team member list is less than or equal to a number of group members in the first group, or a number of team members in the team member list is greater than a number of group members in the first group.

Step 302: Changing a group member of a first group based on the team member list change information, where the first group is associated with the first object in the first system, and the first system is a different system from a communication system where the first group is located.

In specific implementation, the team member list change information may be new team member information or removed team member information.

If the team member list change information is the new team member information, a name of the new team member is obtained from the new team member information, and a search is performed for the name in the group members of the first group. If the name can be found, the group member is not changed. If the name cannot be found, the new team member is added to the first group as an added group member.

If the team member list change information is the removed team member information, a name of the removed team member is obtained from the removed team member information, and a search is performed for the name in the group members of the first group. If the name can be found, the group member corresponding to the name is removed from the first group. If the name cannot be found, no processing is performed.

After receiving the team member list change information, the group member in the first group is correspondingly changed. In this modification method, a user does not need to manually change the group member after entering the first group again, so that the group member change process is more intelligent, simple, quick, and convenient for the user.

In some embodiments, step 302 includes:

Step 302A: Sending a notification message in the first group based on the team member list change information, and changing the group member of the first group based on operation feedback information for the notification message.

In specific implementation, the corresponding notification message may include: a team member adding message and/or a team member removing message.

If the notification message is the team member adding message, a corresponding user (where the user is a group member of the first group) can directly perform an operation in the first group to determine whether to add a new team member to the first group. After the user completes the operation, corresponding operation feedback information is generated, and then it is determined whether to change the group member of the first group based on the operation feedback information.

If the notification message is the team member removing message, the corresponding user can directly perform an operation in the first group to determine whether to remove a removed team member from the first group. After the user completes the operation, corresponding operation feedback information is generated, and then it is determined whether to change the group member of the first group based on the operation feedback information.

Alternatively,

Step 302B: Sending a group member change instruction to a specified chat-bot in the first group based on the team member list change information, and executing, by the chat-bot, an operation of changing the group member of the first group.

In specific implementation, the chat-bot is a group member of the first group. The chat-bot changes the group member in the first group based on the group member change instruction.

The group member change instruction is determined based on the team member list change information. A specific determination process is as follows:

If the team member list change information is the new team member information, a name of the new team member is obtained from the team member list change information, and it is determined whether the name is in the first group. If the name is in the first group, the process ends. If the name is not in the first group, an added group member instruction is obtained and used as the group member change instruction.

If the team member list change information is the removed team member information, a name of the removed team member is obtained from the team member list change information, and it is determined whether the name is in the first group. If the name is in the first group, a removed group member instruction is obtained and used as the group member change instruction. If the name is not in the first group, the process ends.

Then the chat-bot executes the added group member instruction and/or the removed group member instruction to change the group member of the first group.

According to the foregoing solution, the user can manually change the group member of the first group based on the notification message, or the chat-bot can automatically change the group member of the first group. The entire process is simple and convenient.

In addition, the user who performs an operation based on the notification message and the chat-bot are both administrators in the first group.

In some embodiments, the sending a notification message in the first group includes: sending the notification message that is visible only to a first user in the first group, where the first user is an administrator of a group member of the first group and the first group; and
the operation feedback information for the notification message includes: operation feedback information of the first user for the notification message.

The foregoing solution avoids disturbing other group members in the first group. Only the first user who is an administrator can see the corresponding notification message, and only the first user can perform an operation feedback of adding or removing a corresponding group member based on the notification message, thereby facilitating the management of group members in the first group by the first user.

In specific implementation, an execution entity corresponding to the information processing method in each of the embodiments corresponding to FIG. 3 may be the instant messaging system, or may be the first system, or may be that the first system and the instant messaging system complete the information processing method in a collaborative manner. When the two complete the information processing method in a collaborative manner, a specific execution process allocation may be adjusted based on an actual requirement, which is not specifically limited here.

For example, it is determined that the instant messaging system executes the information processing method.

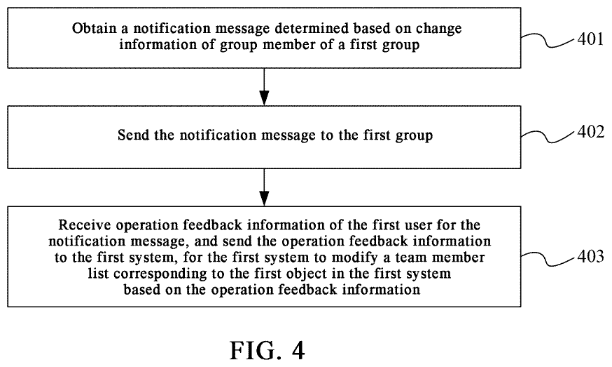

Based on the same inventive concept, an embodiment of the present application provides an information processing method. As shown in FIG. 4, the method includes:

Step 401: Obtaining a notification message determined based on group member change information of a first group, where the first group is associated with a first object in a first system, and the first system is a different system from a communication system where the first group is located.

In specific implementation, the corresponding notification message may be determined by the first system based on the group member change information of the first group.

Step 402: Sending the notification message to the first group, where the notification message is visible only to a first user in the first group, and the first user is an administrator of a group member of the first group and a team member corresponding to the first object.

In specific implementation, after receiving the corresponding notification message, the notification message is sent to the first group by using a specified chat-bot set in the first group, and the notification message is visible only to the first user. In this way, the first user can display the notification message in the first group through a terminal device installed with an instant messaging program.

Step 403: Receiving operation feedback information of the first user for the notification message, and sending the operation feedback information to the first system, for the first system to modify a team member list corresponding to the first object in the first system based on the operation feedback information.

In specific implementation, the first user can perform an operation on the notification message displayed on the terminal device. The specific notification message may be a notification message of adding a team member and/or a notification message of removing a team member. If the notification message is the notification message of adding a team member, the first user can select whether to add a corresponding added group member to the team member list. If the notification message is the notification message of removing a team member, the first user can select whether to remove a corresponding removed group member from the team member list. Then corresponding operation feedback information is formed, and the operation feedback information is sent to the first system. In this way, the first system can perform corresponding modification and adjustment on the team member list according to the modification process of the team member list specifically described in the foregoing embodiment.

According to the foregoing solution, the first user can directly modify the corresponding team member list through the notification message in the first group. In this modification method, the user can directly complete the modification in the first group, without the need to enter the first system again to repeatedly modify the corresponding team member list, so that the modification process is more intelligent, simple, quick, and convenient for the first user.

In some embodiments, step 403 includes:

Step 4031: Determining that the notification message is a notification message of adding a team member in response to the group member change information indicating that a group member is added, where the notification message of adding the team member comprises added group member information and a role selection control, and the role selection control comprises at least one candidate role information.

In specific implementation, the first system adds a corresponding role selection control for each piece of added group member information in the notification message of adding a team member, so that the first user can select one or more corresponding pieces of target role information for the corresponding added group member by using the role selection control.

Step 4032: Receiving the operation feedback information that is obtained by the first user selecting any candidate role information or performing a non-selection operation from at least one candidate role information through the role selection control.

In specific implementation, if the first user does not want to add a specific added group member to the corresponding team member list, the first user can choose not to select the corresponding target role for the added group member in the notification message of adding a team member. After the obtained operation feedback information is sent to the first system, the first system generates a team member adding failure message and returns the team member adding failure message to the first group, so that the first user can view the team member adding failure message.

If the first user wants to add a specific added group member to the corresponding team member list, the first user needs to select at least one target role information for the added group member in the notification message of adding a team member. The at least one target role information and the added group member information are linked, and added to the operation feedback information. Then the operation feedback information is sent to the first system, and the first system adds the added group member information to the team member list as new team member information, and generates a new team member adding success message and returns the new team member adding success message to the first group, so that the first user can view the new team member adding success message.

In some embodiments, after step 403, the method further includes:

Step 404: Receiving a team member change result notification message sent by the first system, and sending the team member change result notification message to the first group, where the team member change result notification message is visible only to the first user in the first group, and the team member change result notification message is obtained by the first system modifying a team member list of the first object associated with the first group based on the operation feedback information.

In specific implementation, the corresponding team member change result notification message includes at least one of: a new team member adding success message, a team member adding failure message, a team member removing success message, and a team member removing failure message. A determination process of each team member change result notification message may be performed based on the description of the foregoing embodiment, and is not described herein again.

If the group member change information of the first group indicates that a group member is removed, the first system can directly remove the removed group member from the team member list, and generate a corresponding team member change result notification message, which is sent in the first group by using the specified chat-bot in the first group. Similarly, the team member change result notification message is also visible only to the first user. Alternatively, a corresponding notification message of removing a team member may be generated based on the foregoing process, and whether to remove the removed group member from the team member list is determined based on an operation of the first user, and then a corresponding team member change result notification message is obtained.

According to the foregoing solution, the first user can view a change result of the corresponding team list in the first group, and can perform subsequent processing in a timely manner if there is a problem in the change result notification message.

In some embodiments, the method further includes:

Step 405: Determining that the team member change result notification message comprises: a team member adding failure message or a team member removing failure message, and carrying a contact entry of a system administrator and/or a contact entry of a feedback group in the team member change result notification message.

Step 406: Displaying a chat window with the system administrator in response to the contact entry of the system administrator being triggered. and/or

Step 407: Displaying a chat window with the feedback group in response to the contact entry of the feedback group being triggered.

According to the foregoing solution, in response to determining that the team member change result notification message includes the team member adding failure message or the team member removing failure message, the corresponding contact entry of the system administrator and/or the contact entry of the feedback group are displayed together in the team member change result notification message. In this way, the first user can be facilitated to trigger to feed back the situation to the corresponding system administrator or the feedback group, so that the corresponding situation can be solved as soon as possible, further facilitating the use of the user.

In specific implementation, an execution entity corresponding to the information processing method in each of the embodiments corresponding to FIG. 4 may be the instant messaging system, or may be the first system, or may be that the first system and the instant messaging system complete the information processing method in a collaborative manner. When the two complete the information processing method in a collaborative manner, a specific execution process allocation may be adjusted based on an actual requirement, which is not specifically limited here.

For example, it is determined that the instant messaging system executes the information processing method.

It should be noted that the method in the embodiments of the present application may be performed by a single device, for example, one computer or server. The method in this embodiment may also be applied to a distributed scenario, and completed by multiple devices in cooperation with each other. In this distributed scenario, one of the multiple devices may only perform one or more steps of the method in the embodiments of the present application, and the multiple devices exchange information with each other to complete the method.

It should be noted that some embodiments of the present application are described above. Other embodiments are within the scope of the appended claims. In some cases, actions or steps recited in the claims may be performed in an order different from that in the embodiments, and still achieve the desired results. In addition, the processes depicted in the accompanying drawings do not necessarily require a specific order or a sequential order to achieve the desired results. In some implementations, multitasking and parallel processing are also possible or may be advantageous.

Based on the same inventive concept, a specific execution process of the information processing method in the foregoing embodiments is described by using a specific application scenario.

The first is a case where a group member is added to a project group.

After a person is added to a project group (that is, the first group), a project administrator (that is, the first member) can quickly add a member (that is, the added group member) to a project team (that is, the team member list).

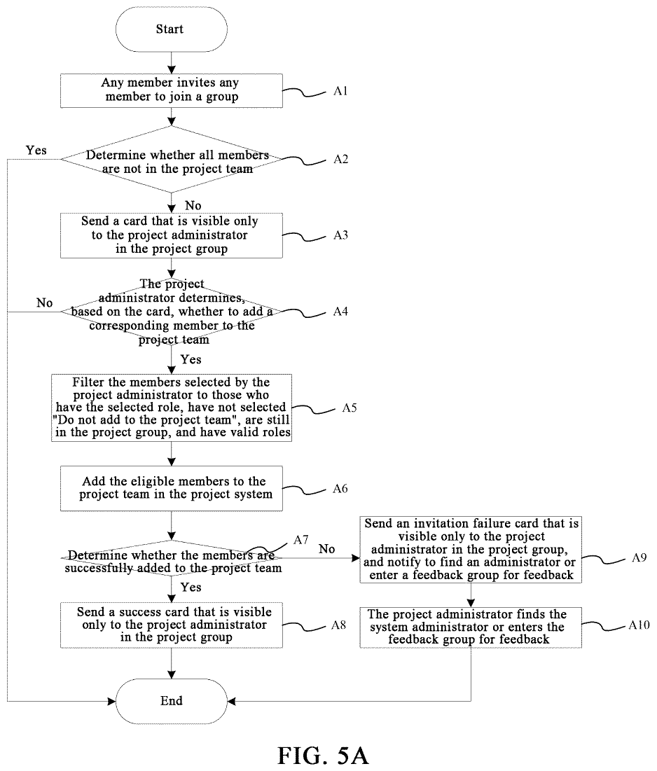

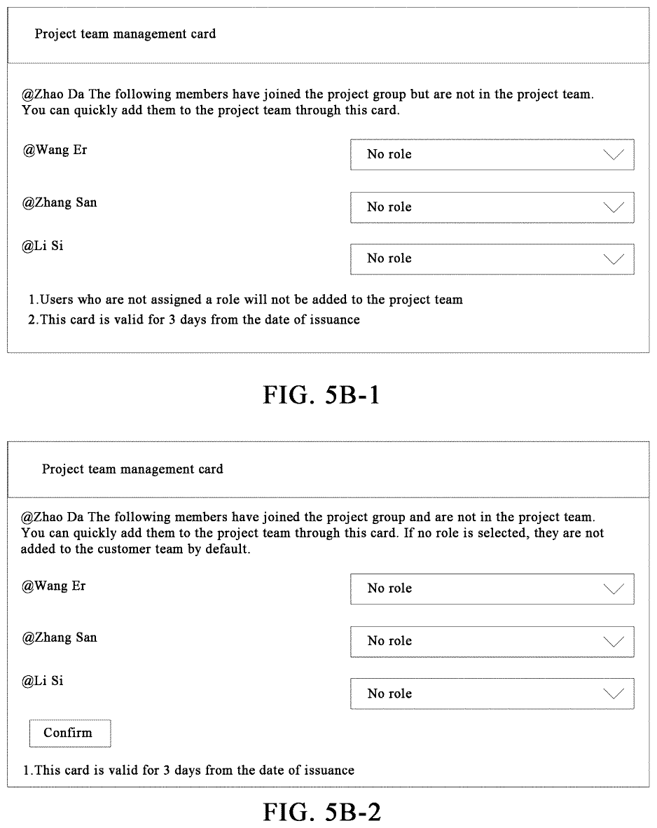

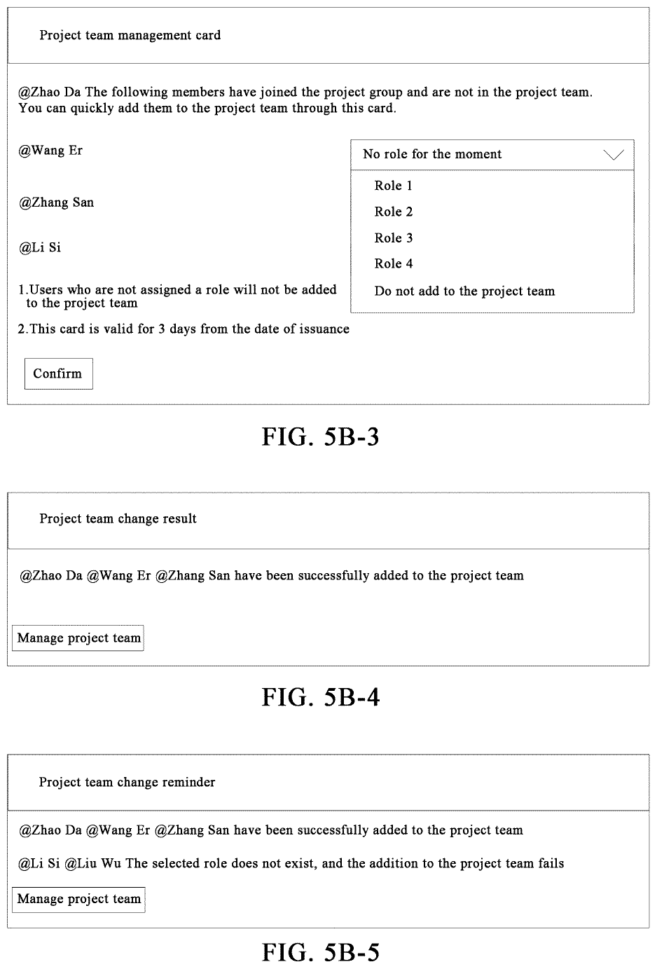

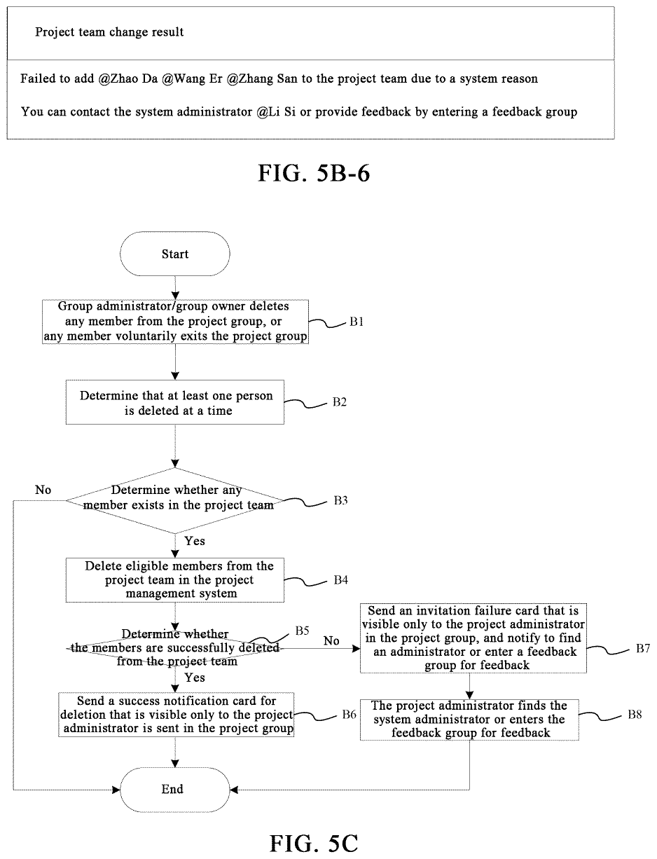

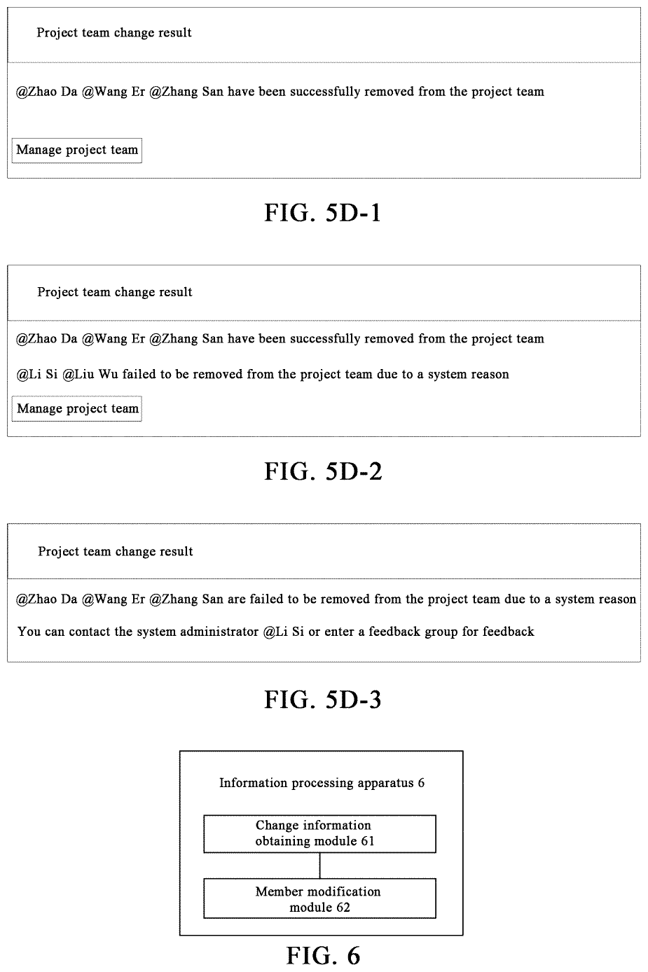

A specific execution process is shown in FIG. 5A:
Step A1: Any member invites any member to join a group.
Step A2: It is determined whether all members are not in the project team. If yes, the process ends. Otherwise, step A3 is performed.
Step A3: An invitation card that is visible only to the project administrator is sent in the project group.
Step A4: The project administrator determines, based on the card, whether to add a corresponding member to the project team. If yes, step A5 is performed. Otherwise, the process ends.
Step A5: Filter the members selected by the project administrator to those who have the selected role, have not selected “Do not add to the project team”, are still in the project group, and have valid roles
Step A6: Add the eligible members to the project team in the project system.
Step A7: Determine whether the members are successfully added to the project team. If yes, step A8 is performed. Otherwise, step A9 is performed.
Step A8: Send a success card that is visible only to the project administrator in the project group, and then the process ends.
Step A9: Send an invitation failure card that is visible only to the project administrator in the project group, and notify to find an administrator or enter a feedback group for feedback.
Step A10: The project administrator finds the system administrator or enters the feedback group for feedback, and then the process ends.

The following specifically describes a case where an added group member is added, and a project team quick management card is sent to the project administrator:

Member added reminder card 1: Project team quick management card.

Sending timing of member added reminder card 1: After any member (other than the project administrator) enters the group, it is determined whether the members other than the project administrator are in the project team.

If any member is not in the project team, a member added reminder card 1 that is visible only to the project administrator is sent in the project group (as shown in FIG. 5B-1 or FIG. 5B-2). If all the members other than the project administrator are in the project team, the member added reminder card is not sent.

The content of member added reminder card 1 is as follows:
Project team quick management
@{The project administrator} The following members have joined the project group but are not yet in the project team. You can add them to the project team through this member added reminder card.
@{Person 1 not in the project team} [Selector 1]
. . .
@{Person n not in the project team} [Selector n]
[Confirm button]

The selector is a role selection control.

An enumeration value of “Added as a project team role or not added” is an enumeration value of a role of the project team in the management background+a fixed enumeration value “Not added”.

Interaction logic of member added reminder card 1

After selecting a corresponding role from a selector in member added reminder card 1 shown in FIG. 5B-3, the project administrator clicks Confirm. The system adds, to the project team in the project management system, members who have selected a role, have not selected “Not added to the project team”, and are still in the project group.

Member added reminder card 2 is a member added reminder card corresponding to a project team change result. The sending timing of member added reminder card 2 is as follows: If data is all successfully submitted to the project management system, member added reminder card 1 is refreshed into a member added reminder card 2 that is visible only to the project administrator in the project group (as shown in FIG. 5B-4).

The content of member added reminder card 2 is as follows:
Project team change result
@{Members successfully submitted} have been successfully added to the project team
[Manage the project team]

When all the members are not added to the project team (none of the members selects an enumeration value or all the members select an enumeration value of not joining the project team), the text of member added reminder card 2 is as follows:
No member is added to the project team in this operation.

Interaction logic of member added reminder card 2

Clicking Manage the project team can jump to a follow-up team details page.

Member added reminder card 3 is used when some members succeed in joining the project team when a plurality of members join the project group. The sending timing of member added reminder card 3 is as follows: If data is partially successfully submitted to the project management system and partially fails, member added reminder card 1 is refreshed into a member added reminder card 3 that is visible only to the project administrator in the project group (as shown in FIG. 5B-5).

The content of member added reminder card 3 is as follows:
Project team change result
@{Members successfully submitted} have been successfully added to the project team
{Failure situation}
[Manage the project team]

The situation that some members fail to join the project team includes the following:
1. A member is not in the project group when the member is added to the project team in the system, and then the member is not added to the project team. An error text: XXX is not currently in the project group, and the addition fails.
2. A role of a member does not exist, resulting in the failure of the member to join the project team. An error text: A role selected by @xxx does not exist, and the addition fails.
3. A member has been in the current role, resulting in the failure of the member to join the project team. An error text: @xxx is already in the selected role.
4. An internal system error. An error text: @xxx fails to be added due to a system cause.

Member added reminder card 4 is a member added reminder card for a total failure after a member clicks Confirm to submit but fails.

Sending timing of member added reminder card 4: If data fails to be submitted to the project management system, the system automatically retries. If data still fails to be submitted after N retries, member added reminder card 1 is refreshed into a style of member added reminder card 4 shown in FIG. 5B-6.

The content of member added reminder card 4 is as follows:
Project team change result
{Failure situation}
Contact a system administrator @{Administrator of the corresponding namespace} or (Enter the group for feedback) [Link to the feedback group]

The failure situations include the following:
1. A member is not in the project group when the member is added to the project team in the system, and then the member is not added to the project team. An error text: XXX is not currently in the project group, and the addition fails.
2. A role of a member does not exist, resulting in the failure of the member to join the project team. An error text: A role selected by @xxx does not exist, and the addition fails.
3. A member has been in the current role, resulting in the failure of the member to join the project team. An error text: @xxx is already in the selected role.
4. An internal system error. An error text: @xxx fails to be added due to a system cause.
5. Another member of this project is operating the project team. An error text: Another member is adding a member. Please retry in the mini program later.
6. A member does not have the permission to operate. An error text: The operation fails due to no permission.

Interaction logic of member added reminder card 4: Clicking Enter the group for feedback jumps to the feedback group in the current space of the corresponding project group.

A principle of adding an added group member to the project team is as follows:
1. A member without application visibility may be added to the project team.
2. One member in the project team may have a plurality of roles.
3. After a member of the project team is changed, a member added reminder card of “Project team quick management” that has been sent is not synchronously refreshed.
4. If the project administrator enters the group, the quick addition member added reminder card is not triggered.

Specific cases include the following:
1. If a person joining the project group does not have application visibility.

The member is normally added to the project team. There will be no problem in accordance with the existing logic, but the avatar of the member cannot be displayed on the front-end page.
2. If a role of the project team changes before the project administrator clicks Confirm after member added reminder card 1 is sent.

If a role ID does not exist, the submission fails directly. If the role ID still exists, the submission succeeds. If the submission fails due to this reason, the successful member added reminder card is labeled.
3. If a member who is not in the project team joins the project team before the project administrator clicks Confirm after member added reminder card 1 is sent.

If the member clicks Confirm again, no special processing is performed, and two records are directly displayed.
4. If a member exits the project group before the project administrator clicks Confirm after member added reminder card 1 is sent, and then the member is not pulled into the project group again.

It is checked whether these persons are in the group. It is told to the members on the successfully submitted member added reminder card that some of them are not in the project group, and therefore are not added to the project team.
5. If a member exits the project group before the project administrator clicks Confirm after member added reminder card 1 is sent, and then the member is pulled into the project group again, two addition cards will be displayed.

If the project administrator adds a member to the project team in the first card and the submission succeeds, but the member is not added to the project team in the second card, the member is still in the project team.

If the project administrator adds a member to the project team in the first card and the submission succeeds, and the member is added to the project team in the second card and the submission succeeds, the member has two roles in the project team.

In the second case, after a person is removed from the project group, the system automatically removes the member from the project team. A specific execution process is shown in FIG. 5C:
Step B1: A group administrator/group owner removes any member from the project group, or any member voluntarily exits the project group.
Step B2: Determine that at least one person is removed at a time.
Step B3: Determine whether any member exists in the project team. Otherwise, the process ends.
Step B4: Remove eligible members from the project team in the project management system.
Step B5: Determine whether the members are successfully removed from the project team. If yes, step B6 is performed. Otherwise, the process ends.
Step B6: Send a success notification card for removing that is visible only to the project administrator is sent in the project group, and then the process ends.
Step B7: Send an invitation failure card that is visible only to the project administrator in the project group, and notify to find an administrator or enter a feedback group for feedback.
Step B8: The project administrator finds the system administrator or enters the feedback group for feedback, and then the process ends.

The following specifically describes a case where a group member is removed, and a removing situation feedback card is sent to the project administrator:

A removing reminder card is sent to the project administrator after a member exits the group.

Removing reminder card 1 (as shown in FIG. 5D-1): A project team successful change result card. A corresponding interaction logic is as follows: After the member exits the group, the corresponding member is removed from the project team in the project management system.

Sending timing of removing reminder card 1: If all the members are successfully removed from the project team and the result is synchronized to the project management system, a removing reminder card 1 that is visible only to the project administrator is sent in the project group.

The content of removing reminder card 1 is as follows:
Project team change result
@{Members successfully removed} have been successfully removed from the project team.

Interaction logic of removing reminder card 1: Clicking “Manage the project team” can jump to a project team details page.

Removing reminder card 2 (as shown in FIG. 5D-2): If some members are successfully removed from the project team, some members fail to be removed from the project team, and the result is synchronized to the project management system, a removing reminder card 2 that is visible only to the project administrator is sent in the project group.

The content of removing reminder card 2 is as follows:
Project team change result
@{Members successfully removed} have been successfully removed from the project team. The members will lose the permission to access this project after leaving the project team.
{Failure situation}

Failure situations corresponding to removing reminder card 2 include the following:
1. A role of a member does not exist, resulting in the failure of the member to be removed from the project team. An error text: A role selected by @xxx does not exist, and the member fails to be removed from the project team.
2. An internal system error. An error text: @xxx fails to be removed from the project team due to a system cause.

Removing reminder card 3 (as shown in FIG. 5D-3): A project team removing total failure change result card.

Sending timing of removing reminder card 3: If the removal fails, the system automatically retries. If all the members still fail to be removed, removing reminder card 3 that is visible only to the project administrator is sent.

The content of removing reminder card 3 is as follows:
Project team change result
{Failure situation}
Contact a system administrator @{Administrator of the corresponding namespace} or (Enter the group for feedback) [Link to the feedback group]

Failure situations corresponding to removing reminder card 3 include the following:
1. A role of a member does not exist, resulting in the failure of the member to be removed from the project team. An error text: A role selected by @xxx does not exist, and the member fails to be removed from the project team.
2. An internal system error. An error text: @xxx fails to be removed from the project team due to a system cause.

Interaction logic of removing reminder card 3: Clicking “Enter the group for feedback” jumps to the feedback group in the current space.

A principle of removing a group member from the project team is as follows: If a member is removed from the project team because the member exits the group, all the records of the project team involving the member are removed.

Specific cases include the following:
1. A member has two roles in a project team, one is a sales role, and the other is a delivery role. When the member exits the project group, the system removes both the two roles of the member.

According to the solutions of the foregoing embodiments, when a group member of the project group is added or removed, a corresponding operation of adding or removing a team member can be performed on a project team corresponding to the project group on a side of the project management system. For the project administrator who is a group member of the project group and an administrator of a team member, the addition or removing of the group member and the addition or removing of the corresponding project team can be directly completed in the project group. The entire operation process is simple and quick, bringing convenience to the project administrator, so that the project administrator is more willing to maintain the project team in the project management system, thereby ensuring that functions of the project team can be fully exerted.

Based on the same inventive concept, corresponding to the information processing method in the embodiment corresponding to FIG. 2, the present application further provides an information processing apparatus 6.

Referring to FIG. 6, the apparatus includes:
a change information obtaining module 61, configured to obtain group member change information of a first group, where the first group is associated with a first object in a first system, and the first system is a different system from a communication system where the first group is located; and
a member modification module 62, configured to modify a team member list corresponding to the first object in the first system based on the group member change information, where a user in the team member list has a first access permission to information of the first object in the first system.

In some embodiments, member modification module 62 includes:
a notification sending unit configured to send a notification message in the first group based on the group member change information; and
a member modification unit configured to modify the team member list corresponding to the first object in the first system based on operation feedback information for the notification message.

In some embodiments, the sending a notification message in the first group includes: sending, in the first group, the notification message that is visible only to a first user, where the first user is a member of the first group and an administrator of the team members corresponding to the first object; and
the operation feedback information for the notification message includes: operation feedback information of the first user for the notification message.

In some embodiments, in response to the group member change information indicating that a group member is added, the notification message is a notification message of adding a team member; and/or
in response to the group member change information indicating that a group member is removed, the notification message is a notification message of removing a team member.

In some embodiments, the notification sending unit includes:
an added group member obtaining subunit configured to, in response to the group member change information indicating that a group member is added, obtain added group member information from the group member change information;
a determining subunit configured to determine whether the added group member information is in the team member list corresponding to the first object; and
a notification sending subunit configured to, in response to the team member list not including the added group member information, generate the notification message of adding a team member and send the notification message of adding a team member in the first group, where the notification message of adding a team member comprises the added group member information.

In some embodiments, the notification message of adding a team member includes: the added group member information and a role selection control, where the role selection control comprises at least one candidate role information; and
the member modification unit is further configured to:
determine that the operation feedback information for the notification message comprises at least one target role information selected by the first user for the added group member information through the role selection control, where the target role information is any of the at least one candidate role information; and add the added group member information to the team member list corresponding to the first object in the first system as new team member information, and assigning the at least one target role information to the new team member information, where different roles of the team members correspond to different permissions of the first object.

In some embodiments, a determination process of the notification sending unit for the notification message of removing a team member includes:
in response to determining that the group member change information indicates that a group member is removed, obtaining removed group member information from the group member change information; determining whether the removed group member information is in the team member list corresponding to the first object; and in response to the team member list including a team member corresponding to the removed group member information, generating a notification message of removing the team member.

In some embodiments, member modification module 62 is further configured to:
in response to determining that the group member change information indicates that a group member is removed, obtain removed group member information from the group member change information; determine whether the removed group member information is in the team member list corresponding to the first object; and in response to the team member list including the team member corresponding to the removed group member information, remove, from the team member list corresponding to the first object in the first system, the team member corresponding to the removed group member information, to complete the modification of the team member list.

In some embodiments, the apparatus further includes a change result sending module configured to:
send, in the first group, a team member change result notification message that is visible only to the first user based on a modification result of the team member list.

In some embodiments, the team member change result notification message includes at least one of:
a team member adding success message, a team member adding failure message, a team member removing success message, or a team member removing failure message.

In some embodiments, in response to determining that the team member change result notification message includes: in response to a team member adding failure message or a team member removing failure message, carrying a contact entry of a system administrator and/or a contact entry of a feedback group in the team member change result notification message.

In some embodiments, the team member adding failure message includes at least one of:
the team member adding failure message obtained in response to determining that the added group member information is not in the first group;
the team member adding failure message obtained in response to determining that the added group member information does not select any piece of target role information;
the team member adding failure message obtained in response to determining that the added group member information is already in the selected target role information;
the team member adding failure message obtained in response to determining that the added group member information is operated by an administrator other than the first user in administrators of team members corresponding to the first object;
the team member adding failure message obtained in response to determining that the added group member information cannot be added to the team member list corresponding to the first object; and
the team member adding failure message obtained in response to determining that the first user who operates the added group member information has no administrator permission.

In some embodiments, the team member removing failure message includes at least one of:
the team member removing failure message obtained in response to determining that role information corresponding to the removed group member information is not in the team member list corresponding to the first object; and
the team member removing failure message obtained in response to determining that the removed group member information cannot be removed from the team member list corresponding to the first object.

In some embodiments, member modification module 62 further includes:
a group member change receiving unit configured to: in response to receiving an addition message of an added group member rejoining the first group after receiving an exit message of the added group member exiting the first group, generate a new notification message, and sending the new notification message in the first group; and
the member modification unit is further configured to:
modify the team member list corresponding to the first object in the first system based on the operation feedback information for the notification message and/or the new notification message.

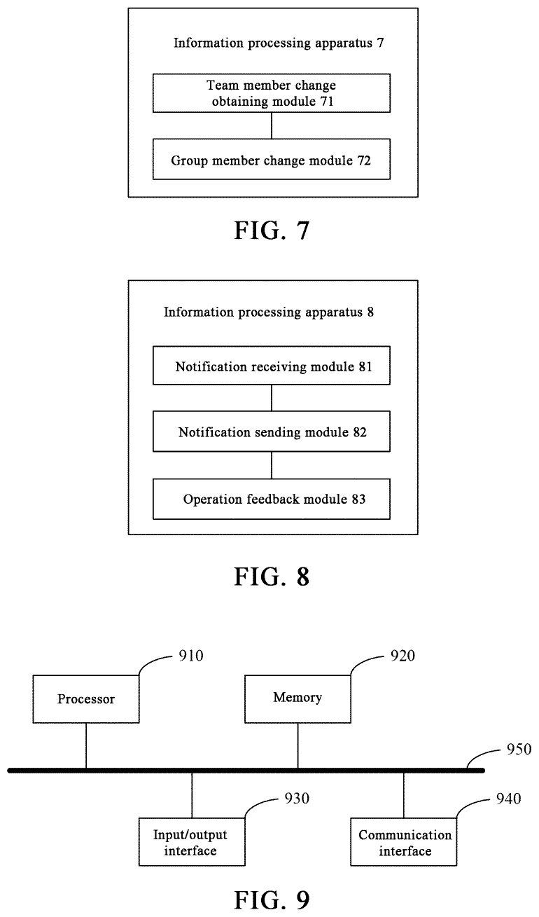

Based on the same inventive concept, corresponding to the information processing method in the embodiment corresponding to FIG. 3, an information processing apparatus 7 is provided. As shown in FIG. 7, the apparatus includes:
a team member list change obtaining module 71 configured to obtain team member list change information corresponding to a first object in a first system, where a user in the team member list has a first access permission to information of the first object in the first system; and
a group member change module 72 configured to change a group member of a first group based on the team member list change information, where the first group is associated with the first object in the first system, and the first system is a different system from a communication system where the first group is located.

In some embodiments, group member change module 72 is further configured to:
send a notification message in the first group based on the team member list change information, and changing the group member of the first group based on operation feedback information for the notification message; or
send a group member change instruction to a specified chat-bot in the first group based on the team member list change information, and executing, by the chat-bot, an operation of changing the group member of the first group.

In some embodiments, group member change module 72 is further configured to:
send the notification message in the first group comprises: sending the notification message that is visible only to a first user in the first group, where the first user is an administrator of a group member of the first group and the first group; and
the operation feedback information for the notification message comprises: operation feedback information of the first user for the notification message.

Based on the same inventive concept, corresponding to the information processing method in the embodiment corresponding to FIG. 4, an information processing apparatus 8 is provided. As shown in FIG. 8, the apparatus includes:
a notification receiving module 81 configured to obtain a notification message determined based on group member change information of a first group, where the first group is associated with a first object in a first system, and the first system is a different system from a communication system where the first group is located;
a notification sending module 82 configured to send the notification message to the first group, where the notification message is visible only to a first user in the first group, and the first user is an administrator of a group member of the first group and a team member corresponding to the first object; and
an operation feedback module 83 configured to receive operation feedback information of the first user for the notification message, and send the operation feedback information to the first system, for the first system to modify a team member list corresponding to the first object in the first system based on the operation feedback information.

In some embodiments, notification receiving module 81 is further configured to:
determine that the notification message is a notification message of adding a team member in response to the group member change information indicating that a group member is added, where the notification message of adding the team member comprises added group member information and a role selection control, and the role selection control comprises at least one candidate role information; and receive the operation feedback information that is obtained by the first user selecting any candidate role information or performing a non-selection operation from at least one candidate role information through the role selection control.

In some embodiments, the apparatus further includes a change result notification module configured to: receive a team member change result notification message sent by the first system, and send the team member change result notification message to the first group, where the team member change result notification message is visible only to the first user in the first group, and the team member change result notification message is obtained by the first system modifying a team member list of the first object associated with the first group based on the operation feedback information.

In some embodiments, the apparatus further includes:
a feedback trigger module configured to:
determine that the team member change result notification message comprises: a team member adding failure message or a team member removing failure message, and carrying a contact entry of a system administrator and/or a contact entry of a feedback group in the team member change result notification message; display a chat window with the system administrator in response to the contact entry of the system administrator being triggered; and/or display a chat window with the feedback group in response to the contact entry of the feedback group being triggered.

For ease of description, the foregoing apparatus is described above by dividing the functions into various modules. Certainly, during implementation of the present application, the functions of the modules may be implemented in a same or a plurality of software and/or hardware.

The apparatus in the foregoing embodiment is configured to implement the corresponding method in any of the foregoing embodiments, and has the beneficial effects of the corresponding method embodiment. Details are not described herein again.

Based on the same inventive concept, corresponding to the method in any of the foregoing embodiments, the present application further provides an electronic device. The electronic device includes a memory, a processor, and a computer program stored in the memory and executable on the processor. When the processor executes the program, the method described in any of the foregoing embodiments is implemented.

FIG. 9 shows a schematic diagram of a more specific hardware structure of an electronic device according to this embodiment. The device may include: a processor 910, a memory 920, an input/output interface 930, a communication interface 940, and a bus 950. The processor 910, the memory 920, the input/output interface 930, and the communication interface 940 are connected to each other within the device through the bus 950 to implement communication.

The processor 910 may be implemented by using a general-purpose CPU (Central Processing Unit), a microprocessor, an ASIC (Application Specific Integrated Circuit), or one or more integrated circuits, and is configured to execute a related program to implement the technical solution provided in the embodiments of this specification.

The memory 920 may be implemented in the form of a ROM (Read Only Memory), a RAM (Random Access Memory), a static storage device, a dynamic storage device, or the like. The memory 920 may store an operating system and other applications. When the technical solution provided in the embodiments of this specification is implemented by using software or firmware, the related program code is stored in the memory 920 and invoked and executed by the processor 910.

The input/output interface 930 is configured to connect to an input/output module to implement information input and output. The input/output module may be configured as a component in the device (not shown in the figure), or may be externally connected to the device to provide a corresponding function. The input device may include a keyboard, a mouse, a touch screen, a microphone, various sensors, and the like, and the output device may include a display, a speaker, a vibrator, an indicator light, and the like.

The communication interface 940 is configured to connect to a communication module (not shown in the figure) to implement communication and interaction between this device and another device. The communication module may implement communication in a wired manner (for example, USB or network cable) or in a wireless manner (for example, mobile network, Wi-Fi, or Bluetooth).

The bus 950 includes a path to transmit information between components (for example, the processor 910, the memory 920, the input/output interface 930, and the communication interface 940) of the device.

It should be noted that although the foregoing device shows only the processor 910, the memory 920, the input/output interface 930, the communication interface 940, and the bus 950, in an actual implementation process, the device may further include other components necessary for normal running. In addition, a person skilled in the art may understand that the foregoing device may include only components necessary for implementing the solution of the embodiments of this specification, instead of all the components shown in the figure.

The electronic device in the foregoing embodiment is configured to implement the corresponding information processing method or text correction method in any of the foregoing embodiments, and has the beneficial effects of the corresponding information processing method or text correction method embodiment. Details are not described herein again.

Based on the same inventive concept, corresponding to the method in any of the foregoing embodiments, the present application further provides a non-transitory computer-readable storage medium storing computer instructions, where the computer instructions are configured to enable the computer to perform the method according to any of the foregoing embodiments.

The computer-readable medium in this embodiment includes a permanent and non-permanent, movable and non-movable medium, which may implement information storage by any method or technology. The information may be computer-readable instructions, a data structure, a program module, or other data. Examples of the computer storage medium include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette tape, magnetic tape and magnetic disk storage or other magnetic storage devices, or any other non-transmission medium. The computer-readable medium can be used to store information accessible by the computing device.

The computer instructions stored in the storage medium in the foregoing embodiment are configured to enable the computer to perform the method according to any of the foregoing embodiments, and has the beneficial effects of the corresponding method embodiment. Details are not described herein again.

A person of ordinary skill in the art should understand that the discussions of any of the foregoing embodiments are exemplary only, and are not intended to imply that the scope of the present application (including the claims) is limited to these examples; under the concept of the present application, the technical features in the foregoing embodiments or different embodiments may also be combined, and the steps may be implemented in any order, and there are many other changes in different aspects of the embodiments of the present application as described above. For the sake of brevity, they are not provided in the details.

In addition, in order to simplify the description and discussion, and in order not to make the embodiments of the present application difficult to understand, well-known power/ground connections to integrated circuit (IC) chips and other components may or may not be shown in the provided drawings. Further, the apparatus may be shown in a block diagram form in order to avoid making the embodiments of the present application difficult to understand, and this also considers the following fact, that details of implementation of the block diagram apparatus are highly dependent on a platform on which the embodiments of the present application are to be implemented (that is, these details should be completely within the understanding of those skilled in the art). In the case of specific details (for example, a circuit) being set forth to describe exemplary embodiments of the present application, it will be apparent to those skilled in the art that the embodiments of the present application may be implemented without these specific details or with variations of these specific details. Therefore, these descriptions should be considered as illustrative rather than restrictive.

Although the present application has been described in conjunction with specific embodiments of the present application, many alternatives, modifications, and variations thereof will be apparent to those of ordinary skill in the art based on the foregoing description. For example, other memory architectures (such as dynamic RAM (DRAM)) may use the embodiments discussed.

The embodiments of the present application are intended to cover all such substitutions, modifications, and variations that fall within the broad scope of the appended claims. Therefore, any omission, modification, equivalent replacement, improvement, etc. made within the spirit and principle of the embodiments of the present application shall fall within the protection scope of the present application.

1. An information processing method, wherein the method comprises:
obtaining group member change information of a first group, wherein the first group is associated with a first object in a first system, and the first system is a different system from a communication system where the first group is located; and
modifying a team member list corresponding to the first object in the first system based on the group member change information, wherein a user in the team member list has a first access permission to information of the first object in the first system.

2. The method according to claim 1, wherein modifying the team member list corresponding to the first object in the first system based on the group member change information comprises:
sending a notification message in the first group based on the group member change information; and
modifying the team member list corresponding to the first object in the first system based on operation feedback information for the notification message.

3. The method according to claim 2,
wherein:
sending the notification message in the first group comprises: sending, in the first group, the notification message that is visible only to a first user, wherein the first user is a member of the first group and an administrator of the team members corresponding to the first object; and
the operation feedback information for the notification message comprises: operation feedback information of the first user for the notification message, or
wherein:
in response to the group member change information indicating that a group member is added, the notification message is a notification message of adding a team member; and/or
in response to the group member change information indicating that a group member is removed, the notification message is a notification message of removing a team member.

4. (canceled)

5. The method according to claim 3, wherein sending the notification message in the first group based on the group member change information comprises:
in response to the group member change information indicating that a group member is added, obtaining added group member information from the group member change information;
determining whether the added group member information is in the team member list corresponding to the first object; and
in response to the team member list not including the added group member information, generating the notification message of adding a team member and sending the notification message of adding a team member in the first group, wherein the notification message of adding a team member comprises the added group member information.

6. The method according to claim 5, wherein the notification message of adding a team member comprises: the added group member information and a role selection control, wherein the role selection control comprises at least one candidate role information; and
modifying the team member list corresponding to the first object in the first system based on the operation feedback information for the notification message comprises:
determining that the operation feedback information for the notification message comprises at least one target role information selected by the first user for the added group member information through the role selection control, wherein the target role information is any of the at least one candidate role information; and
adding the added group member information to the team member list corresponding to the first object in the first system as new team member information, and assigning the at least one target role information to the new team member information, wherein different roles of the team members correspond to different permissions of the first object.

7. The method according to claim 3, wherein a determination process of the notification message of removing the team member comprises:
in response to determining that the group member change information indicates that a group member is removed, obtaining removed group member information from the group member change information;
determining whether the removed group member information is in the team member list corresponding to the first object; and
in response to the team member list including a team member corresponding to the removed group member information, generating a notification message of removing the team member.

8. The method according to claim 1, wherein modifying the team member list corresponding to the first object in the first system based on the group member change information comprises:
in response to determining that the group member change information indicates that a group member is removed, obtaining removed group member information from the group member change information;
determining whether the removed group member information is in the team member list corresponding to the first object; and
in response to the team member list including the team member corresponding to the removed group member information, removing, from the team member list corresponding to the first object in the first system, the team member corresponding to the removed group member information, to complete the modification of the team member list.

9. The method according to claim 2, wherein the method further comprises, after the modification of the team member list is completed:
sending, in the first group, a team member change result notification message that is visible only to the first user based on a modification result of the team member list.

10. The method according to claim 9, wherein the team member change result notification message comprises at least one of:
a team member adding success message, a team member adding failure message, a team member removing success message, or a team member removing failure message.

11. The method according to claim 10, wherein, determining the team member change result notification message comprises: in response to a team member adding failure message or a team member removing failure message, carrying a contact entry of a system administrator and/or a contact entry of a feedback group in the team member change result notification message.

12. The method according to claim 10, wherein the team member adding failure message comprises at least one of:
the team member adding failure message obtained in response to determining that the added group member information is not in the first group;
the team member adding failure message obtained in response to determining that no target role information is selected for the added group member information;
the team member adding failure message obtained in response to determining that the added group member information is already in the selected target role information;
the team member adding failure message obtained in response to determining that the added group member information is operated by an administrator other than the first user in administrators of team members corresponding to the first object;
the team member adding failure message obtained in response to determining that the added group member information cannot be added to the team member list corresponding to the first object; and
the team member adding failure message obtained in response to determining that the first user operating the added group member information has no administrator permission.

13. The method according to claim 10, wherein the team member removing failure message comprises at least one of:
the team member removing failure message obtained in response to determining that role information corresponding to the removed group member information is not in the team member list corresponding to the first object; and
the team member removing failure message obtained in response to determining that the removed group member information cannot be removed from the team member list corresponding to the first object.

14. The method according to claim 2, wherein the method further comprises, before modifying the team member list corresponding to the first object in the first system based on the operation feedback information for the notification message:
in response to receiving an addition message of an added group member rejoining the first group after receiving an exit message of the added group member exiting the first group, generating a new notification message, and sending the new notification message in the first group; and
modifying the team member list corresponding to the first object in the first system based on the operation feedback information for the notification message comprises:
modifying the team member list corresponding to the first object in the first system based on the operation feedback information for the notification message and/or the new notification message.

15. An information processing method, comprising:
obtaining team member list change information corresponding to a first object in a first system, wherein a user in the team member list has a first access permission to information of the first object in the first system; and
changing a group member of a first group based on the team member list change information, wherein the first group is associated with the first object in the first system, and the first system is a different system from a communication system where the first group is located.

16. The method according to claim 15, wherein changing the group member of the first group based on the team member list change information comprises:
sending a notification message in the first group based on the team member list change information, and changing the group member of the first group based on operation feedback information for the notification message; or
sending a group member change instruction to a specified chat-bot in the first group based on the team member list change information, and executing, by the chat-bot, an operation of changing the group member of the first group.

17. The method according to claim 16, wherein
sending the notification message in the first group comprises: sending the notification message that is visible only to a first user in the first group, wherein the first user is an administrator of a group member of the first group and the first group; and
the operation feedback information for the notification message comprises: operation feedback information of the first user for the notification message.

18. An information processing method, comprising:
obtaining a notification message determined based on group member change information of a first group, wherein the first group is associated with a first object in a first system, and the first system is a different system from a communication system where the first group is located;
sending the notification message to the first group, wherein the notification message is visible only to a first user in the first group, and the first user is an administrator of a group member of the first group and a team member corresponding to the first object; and
receiving operation feedback information of the first user for the notification message, and sending the operation feedback information to the first system, for the first system to modify a team member list corresponding to the first object in the first system based on the operation feedback information.

19. The method according to claim 18, wherein receiving the operation feedback information for the notification message comprises:
determining that the notification message is a notification message of adding a team member in response to the group member change information indicating that a group member is added, wherein the notification message of adding the team member comprises added group member information and a role selection control, and the role selection control comprises at least one candidate role information; and
receiving the operation feedback information that is obtained by the first user selecting any candidate role information or performing a non-selection operation from at least one candidate role information through the role selection control.

20. The method according to claim 18, wherein the method further comprises, after the operation feedback information is sent to the first system:
receiving a team member change result notification message sent by the first system, and sending the team member change result notification message to the first group, wherein the team member change result notification message is visible only to the first user in the first group, and the team member change result notification message is obtained by the first system modifying a team member list of the first object associated with the first group based on the operation feedback information.

21. The method according to claim 20, further comprising:
determining that the team member change result notification message comprises: a team member adding failure message or a team member removing failure message, and carrying a contact entry of a system administrator and/or a contact entry of a feedback group in the team member change result notification message;
displaying a chat window with the system administrator in response to the contact entry of the system administrator being triggered; and/or
displaying a chat window with the feedback group in response to the contact entry of the feedback group being triggered.

22-26. (canceled)
